(19) United States
(12) Patent Application Publication
(10) Pub. No.: US 2004/0061750 A1
(43) Pub. Date: Apr. 1, 2004

(54) Ink cartridge that prevets blockage of a connecting hole of an intermediate partition

(75) Inventors: Seo-Hyun Cho, Sungnam-City (KR); Myung-song Jung, Gunpo-City (KR); Young-su Lee, Suwon-City (KR); Hyung-hyu Hwang, Suwon-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-city (KR)

(21) Appl. No.: 10/649,933

(22) Filed: Aug. 28, 2003

(30) Foreign Application Priority Data
Sep. 30, 2002 (KR) 2002-59365

(51) Int. Cl. B41J 2/175

(52) U.S. Cl. 347/86

(57) ABSTRACT

An ink cartridge including at least one first chamber storing an ink, at least one second chamber having an air inflow hole formed at an upper portion thereof to be exposed to an ambient air and an ink supply portion formed at a lower portion thereof and having an ink supply port supplying an ink, the second chamber expanding with a negative pressure generating medium storing the ink, an intermediate partition having a connecting hole defined in a lower portion thereof connecting the first and the second chambers to each other, the intermediate partition dividing the first and the second chamber, and a connecting hole blockage preventing structure formed with respect to the connecting hole, at least preventing the negative pressure generating medium adjacent to the connecting hole from being partially compressed and providing an additional air-liquid transfer space with respect to the connecting hole, to thereby prevent the connecting hole from being blocked with the negative pressure generating medium expanding in the second chamber. The ink cartridge provides stable supply of ink from the ink chamber to the negative pressure generating chamber.

### CROSS-REFERENCE TO RELATED APPLICATIONS

This application claims the benefit of Korean Application No. 2002-59365, filed Sep. 30, 2002, in the Korean Intellectual Property Office, the disclosure of which is incorporated herein by reference.

### BACKGROUND OF THE INVENTION

1. Field of the Invention

The present invention relates to an ink cartridge used in a printing apparatus such as an ink jet printer, and more particularly, it relates to an ink cartridge having a connecting hole blockage preventing structure that prevents a connecting hole of a intermediate partition between an ink chamber and a negative pressure generating chamber from being blocked by a negative pressure generating medium such as porous material expanding in the negative pressure generating chamber, thereby providing a stable inflow of ink from the ink chamber to the negative pressure generating chamber.

2. Description of the Related Art

Generally, a printing apparatus prints a color image using four color inks of magenta, cyan, yellow, and black. In order to supply such four color inks to a print head of the printing apparatus, the printing apparatus uses a color ink cartridge that stores the magenta, cyan, and yellow inks and a mono or black ink cartridge that stores the black ink.

FIG. 1 schematically shows a color ink cartridge 1 for a general ink jet printer by way of an example.

The ink cartridge 1 includes three ink storing chambers 60 corresponding to three color inks of magenta, cyan, and yellow, one of which is shown in the drawing. Each ink storing chamber 60 is divided by an intermediate partition 83 into an ink chamber 60a that stores ink and a negative pressure generating chamber 60b. The intermediate partition 83 has a connecting hole formed in a bottom portion thereof.

As shown in FIG. 2, a bottom 61 of the ink cartridge 1 formed on a lower portion of the connecting hole 89 is provided with a protruding rib 12 guaranteeing a stable supply of ink from the ink chamber 60a to the negative pressure generating chamber 60b in case that air flowing into the connecting hole 89 through an air supply groove 88 generates a big-sized air bubble to thus block the connecting hole 89 with the air bubble.

The negative pressure generating chamber 60b is expands with a negative pressure generating medium 84 made of porous material such as foam, with the negative pressure generating medium 84 being compressed along an boundary into a more compact state, forming a compressed portion 84a. A filter 71 is disposed between the negative pressure generating medium 84 and an ink supply port 28.

On a lower surface of a cover 22 of the ink cartridge 1 a rib having a plurality of protrusions 72 is provided. The protrusions 72 are spaced apart from one another, forming predetermined spaces between the negative pressure medium 84 and the cover 22.

The cover 22 has an ink injection hole (not shown), an air inflow hole 76, an air inflow groove (not shown) to be exposed to an external ambient air, and a sinusoidal groove (not shown) connecting the air inflow hole 76 to the air inflow groove.

The air inflow groove is sealed by a membrane (not shown) when the ink cartridge 1 is not in use. Before using the ink cartridge 1, the membrane is removed, thereby exposing the air inflow groove to the external ambient air. The membrane has a tongue allowing a part of the membrane to be easily removed.

Hereinbelow, descriptions are made about the operation of the ink cartridge 1 as constructed above. Before using the ink cartridge 1, the membrane is removed by pulling the tongue, so that the air inflow groove is exposed. As a result, the negative pressure generating chamber 60b of the ink storing chamber 60 is exposed to the external ambient air through the sinusoidal groove and the air inflow groove.

After that, the ink cartridge 1 is mounted in a cartridge holder (not shown) of the printer and performs a fluid communication with a print head (not shown). When the printing starts to be operated, a negative pressure generated at the print head attracts ink that is stored in the negative pressure generating chamber 60b of the ink storing chamber 60 using the negative pressure generating medium 84. At this time, since the negative pressure generating chamber 60b is exposed to the ambient air through the air inflow hole, the sinusoidal groove, and the air inflow groove, it maintains the negative pressure constantly. Accordingly, air, dust and the like are removed from the ink by the filter 71 so that only the ink is supplied to the print head.

As the ink is consumed, an ink level 86 in the negative pressure generating chamber 60b reaches an upper end of the air supply groove 88 formed in the intermediate partition 83. Then, the air in the negative pressure generating chamber 60b flows into the ink chamber 60a through the air supply groove 88 and the connecting hole 89.

Due to the flowing air, the pressure of the ink chamber 60a increases to thus allow a certain amount of the ink 85 to flow into the negative pressure generating chamber 60b subjected to a predetermined negative pressure through the connecting hole 89.

As such operations repeat, the supply of the ink 85 to the negative pressure generating chamber 60b continues until the ink 85 of the ink chamber 60a is completely consumed.

However, the negative generating medium 84 expanding in the negative pressure generating chamber 60b to maintain the constant negative pressure in the ink cartridge 1, as constructed above, is generally compressed along the boundary and forms the compressed portion 84a.

Accordingly, when the negative pressure generating medium 84 to be expand in the negative pressure generating chamber 60b is poorly assembled, a space between the connecting hole 89 formed in the intermediate partition 83 and the protruding rib 12 formed on the bottom 61 of the lower portion of the connecting hole 89 is frequently blocked with the compressed portion 84a that is formed as the negative pressure generating medium 84 expands in the negative pressure generating chamber 60b, being compressed along the boundary, as shown in FIG. 3. If that happens, the connecting hole 89 is hindered from serving its air-liquid transfer function of injecting the air bubble to the ink chamber 60a and supplying the ink 85 to the negative generating chamber 60b.

That is, as the space between a bottom of the intermediate partition 83 and the protruding rib 12 is blocked with the compressed portion 84a of the negative pressure generating medium 84 as described above, the air-liquid transfer performance of the connecting hole 89 is weakened. Thus, the ink in the ink chamber 60a is not smoothly supplied to the negative pressure generating chamber 60b. Also, after the ink in the negative pressure generating chamber 60b is completely consumed, image quality is suddenly deteriorated.

Especially, when the connecting hole 89 does not completely perform the air-liquid transfer function, the ink 85 in the ink chamber 60a is never supplied to the negative pressure generating chamber 60b. Accordingly, the ink cartridge 1 has to be replaced with a new one as the ink in the negative pressure generating chamber 60b is consumed. For this reason, there occurs a problem that a lifespan of the ink cartridge 1 is reduced.

### SUMMARY OF THE INVENTION

An aspect of the present invention is to provide an ink cartridge having a connecting hole blockage preventing structure preventing a connecting hole of an intermediate partition between an ink chamber and a negative pressure generating chamber from being blocked with a negative pressure generating medium, thereby stably supplying the ink from the ink chamber to the negative pressure generating chamber.

Another aspect of the present invention is to provide an ink cartridge having a connecting hole blockage preventing structure of a simplified structure and a fabrication.

Still another aspect of the present invention is to provide an ink cartridge having a connecting hole blockage preventing structure capable of selectively using a negative pressure generating medium of a high compression ratio in response to a change of environment such as temperature and pressure.

Additional and/or other aspects and advantages of the invention will be set forth in part in the description which follows and, in part, will be obvious from the description, or may be learned by practice of the invention.

The above and/or other aspects are achieved by providing an ink cartridge comprising at least one first chamber storing an ink, at least one second chamber having an air inflow hole formed at an upper portion thereof to be exposed to an ambient air and an ink supply portion formed at a lower portion thereof and having an ink supply port supplying the ink, the second chamber expanding with a negative pressure generating medium storing the ink, and an intermediate partition having a connecting hole defined in a lower portion thereof connecting the first and the second chambers to each other, the intermediate partition dividing the first and the second chamber, wherein a first volume is larger than a second volume, the first volume being defined by a first face forming an ink contact surface of the negative pressure generating medium adjacent the connection hole, a second face forming a bottom surface of the intermediate partition in the connecting hole, a third face forming a bottom of the ink cartridge and a first vertical plane extending vertically from a center plane of the intermediate partition and the second volume being defined by the first vertical plane, the second face, the third face and a second vertical plane extending vertically from a wall surface of the intermediate partition toward the first chamber, thereby preventing the connecting hole from being blocked with the negative pressure generating medium expanding in the second chamber.

According to the preferred embodiment of the present invention, the third face includes an inclined surface extending from a position, which is separated by a predetermined distance from a third vertical plane vertically extending from a wall surface of the intermediate partition toward the second chamber, to a position at which the ink supply portion is disposed, the inclined surface being inclined at a predetermined obtuse angle with respect to a horizontal surface.

In an embodiment of the invention, the position being away from the third vertical plane by the predetermined distance is disposed at a side of the second chamber.

In this case, a lower surface of the negative pressure generating medium to expand in the second chamber adjacent to the intermediate partition has an inclined angle corresponding to the inclined surface before the negative pressure generating medium expands in the second chamber, thereby preventing the negative pressure generating medium from being compressed and expanding in a triangular prism-shaped space that is defined by an extended plane from the inclined surface of the third face, a non-inclined surface of the third face other than the inclined surface, and the third vertical plane as the negative pressure generating medium expands in the second chamber. At this point, a corner of the lower surface of the negative pressure generating medium adjacent to the triangular prism-shaped space has a cut out portion formed in any one shape of a rounded shape, an inclined shape, and a stepped shape, thereby helping prevent the negative pressure generating medium from being compressed and expanding in the triangular prism-shaped space.

Also, the obtuse angle of the inclined surface ranges from 90° to 180°. By being formed at the obtuse angle from 90° to 180°, the inclined surface can prevent air bubbles from horizontally moving toward the ink supply port of the ink supply portion along the third face and thereby choking it when the air bubbles are supplied through the connecting hole from the second chamber to the first chamber.

Selectively, the position being away from the third vertical plane by the predetermined distance is disposed at a side of the first chamber.

In this case, a lower surface of the negative pressure generating medium to expand in the second chamber adjacent to the intermediate partition has an inclined angle corresponding to the inclined surface before the negative pressure generating medium expands in the second chamber, thereby preventing the negative pressure generating medium from expanding in a triangular prism-shaped space that is formed by the inclined surface of the third face, an extended plane from a non-inclined surface of the third face other than the inclined surface, and the third vertical plane. At this point, a corner of the lower surface of the negative pressure generating medium adjacent to the triangular prism-shaped space includes a cut out portion formed in any one shape of a rounded shape, an inclined shape, and a stepped shape, thereby helping prevent the negative pressure generating medium from being compressed and expanding in the triangular prism-shaped space.

Also, the obtuse angle of the inclined surface ranges from 90° to 180°.

Selectively, the ink cartridge can further include only a cut out portion formed at a corner of a lower surface of the negative pressure generating medium adjacent to the connecting hole.

At this point, in an embodiment of the invention, the cut out portion is formed in any one of a rounded shape, an inclined shape, and a stepped shape. Also, the third face can include an inclined surface extending from a position, at which a third vertical plane vertically extending from a wall surface of the intermediate partition toward the second chamber is disposed, to a position at which the ink supply portion is disposed, the inclined surface being inclined an obtuse angle with respect to a horizontal surface, or be composed of a horizontal surface portion parallel to the horizontal plane.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a side section view showing a conventional ink cartridge;

FIG. 2 is a partial front view of a connecting hole formed in the intermediate partition of the ink cartridge of FIG. 1;

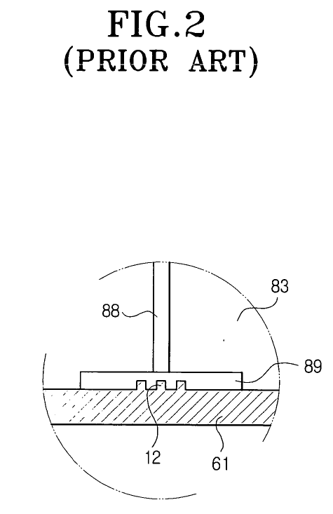

FIG. 3 is a partial side section view showing the connecting hole of the intermediate partition of the ink cartridge of FIG. 1 being blocked with the negative pressure generating medium;

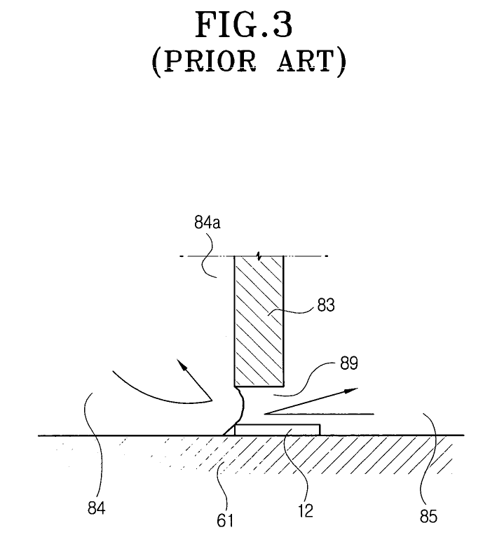

FIG. 4 is a side section view showing an ink cartridge according to an embodiment of the present invention;

FIG. 5 is a partial side section view showing a connecting hole blockage preventing structure for preventing a connecting hole of an intermediate partition of the ink cartridge of FIG. 4 from being blocked with a negative pressure generating medium by way of an example;

FIG. 6 is a partial side section view showing a modified example of the connecting hole blockage preventing structure employed in the ink cartridge according to the present invention;

FIGS. 7A to 7C are side section views showing other modified examples of the connecting hole blockage preventing structures employed in the ink cartridge according to the present invention; and

FIGS. 8A to 8C are side section views showing still other modified examples of the connecting hole blockage preventing structures employed in the ink cartridge according to the present invention;

### DETAILED DESCRIPTION OF THE PREFERRED EMBODIMENTS

Reference will now be made in detail to an ink cartridge according to an embodiment of the present invention, examples of which are illustrated in the accompanying drawings, wherein like reference numerals refer to the like elements throughout. The embodiments are described below in order to explain the present invention by referring to the figures.

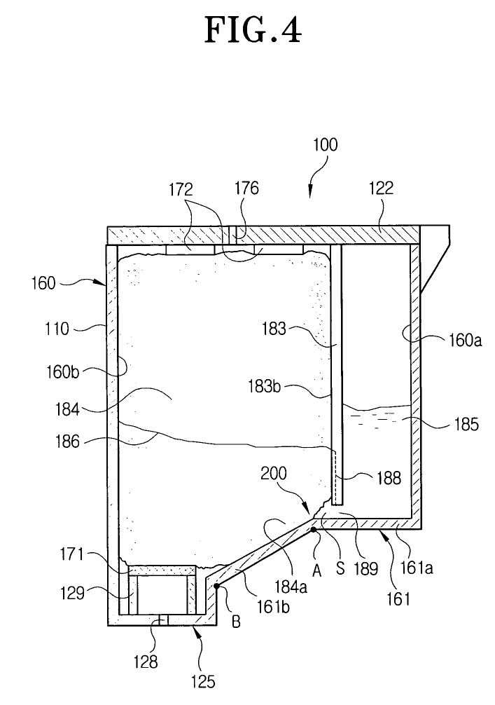

FIG. 4 schematically shows a color ink cartridge 100 according to the present invention. The color ink cartridge 100 includes a body 110 having three ink storing chambers 160 for storing three color inks of magenta, cyan, and yellow, one of which is shown in drawings.

Each ink storing chamber 160 of the body 110 is divided by an intermediate partition 183 into an ink chamber 160a storing ink and a negative pressure generating chamber 160b.

The negative pressure generating chamber 160b expands with a negative pressure generating medium 184 including a porous material such as foam to store ink 185. The negative pressure generating medium 184 closely contacts an inner wall of the negative pressure generating chamber 160b, forming a compressed portion 184a. A filter 171 is disposed between the negative pressure generating medium 184 and an ink supply port 128 of an ink supply portion 125 and disposed on a stand pipe 129 guiding a flow of the ink 185.

Since other elements of the ink storing chamber 160 are identical to those of the conventional ink cartridge 1, detailed descriptions thereof are omitted.

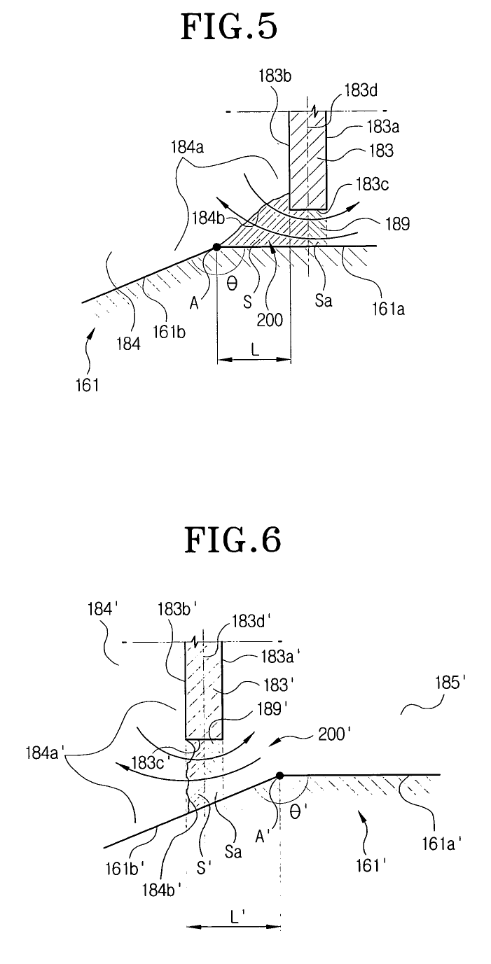

A connecting hole blockage preventing structure 200 is disposed under the intermediate partition 183 in which a connecting hole 189 connects the ink chamber 160a and the negative pressure generating chamber 160b to each other and includes an ink supply groove 188. The connecting hole blockage preventing structure 200 provides first and second air liquid transfer spaces S and Sa, as shown in FIG. 5, around the connecting hole 189 as the negative pressure generating medium 184 expands in the negative pressure generating chamber 160b.

As shown in FIG. 5, the connecting hole blockage preventing structure 200 is formed so that the first air liquid transfer space S is larger than the second air liquid transfer space Sa to prevent the connecting hole 189 from being blocked with the negative pressure generating medium 184 expanding in the negative pressure generating chamber 160b. The first air liquid transfer space S is defined by a first face 184b forming an ink contact surface of the negative pressure generating medium 184 adjacent the connection hole 189, a second face 183c forming a bottom surface of the intermediate partition 183 in the connecting hole 189, a third face 161, as shown in FIG. 4, forming a bottom of the body 110 and a first vertical plane extending vertically from a center face 183d of the intermediate partition 183, whereas the second air liquid transfer space Sa is defined by the first vertical plane, the second face 183c, the third face 161, as shown in FIG. 4, and a second vertical plane extending vertically from a wall surface 183a of the intermediate partition 183 toward the ink chamber 160a.

The first air liquid transfer space S is larger than the second air liquid transfer space Sa because the third face 161 forming a portion of the connecting hole blockage preventing structure 200 includes an inclined surface 161b extending from a position “A” to a position “B”, as shown in FIG. 4, at which the ink supply portion 125 having the ink supply port 128 (Refer to FIG. 4) is disposed, and being inclined at a predetermined angle θ, e.g., at an obtuse angle from 90° to 180° with respect to a horizontal surface, wherein the position “A” is located toward the negative pressure generating chamber 160b by a predetermined distance “L” from a third vertical plane extending vertically from a wall surface 183b of the intermediate partition 183 toward the negative pressure generating chamber 160.

By being formed at the obtuse angle from 90° to 180° with respect to a horizontal surface, the inclined surface 161b can prevent air bubbles from horizontally moving toward the ink supply port 128 of the ink supply portion 125 along the third face 161 and thereby choking it when the air bubbles are supplied through the connecting hole 189 from the negative pressure generating chamber 160b to the ink chamber 160a, besides allowing the first air liquid transfer space S to be larger than the second air liquid transfer space Sa.

Also, a lower surface of the negative pressure generating medium 184 expanding in the negative pressure generating chamber 160b adjacent to the intermediate partition 183 has an inclined angle substantially corresponding to the angle of the inclined surface 161b. Accordingly, as the negative pressure generating medium 184 expands in the negative pressure generating chamber 160b, a triangular prism-shaped space is formed by an extended plane from the inclined surface 161b of the third face 161, a non-inclined surface 161a of the third face 161 other than the inclined surface 161b, and an extended surface from the wall surface 183b of the intermediate partition 183, i.e. the third vertical plane, thereby preventing the negative pressure generating medium 184 from closely contacting with the negative pressure generating chamber 160b. That is, due to the formation of the triangular prism-shaped space, the compressed portion 184a is not formed.

Also, in order to help prevent the negative pressure generating medium 184 from being compressed and expanding in the triangular prism-shaped space, a corner of the lower surface of the negative pressure generating medium 184 adjacent to the triangular prism-shaped space may be additionally provided with a cut out portion (not shown) that is cut into a rounded shape, a inclined shape, or a stepped shape.

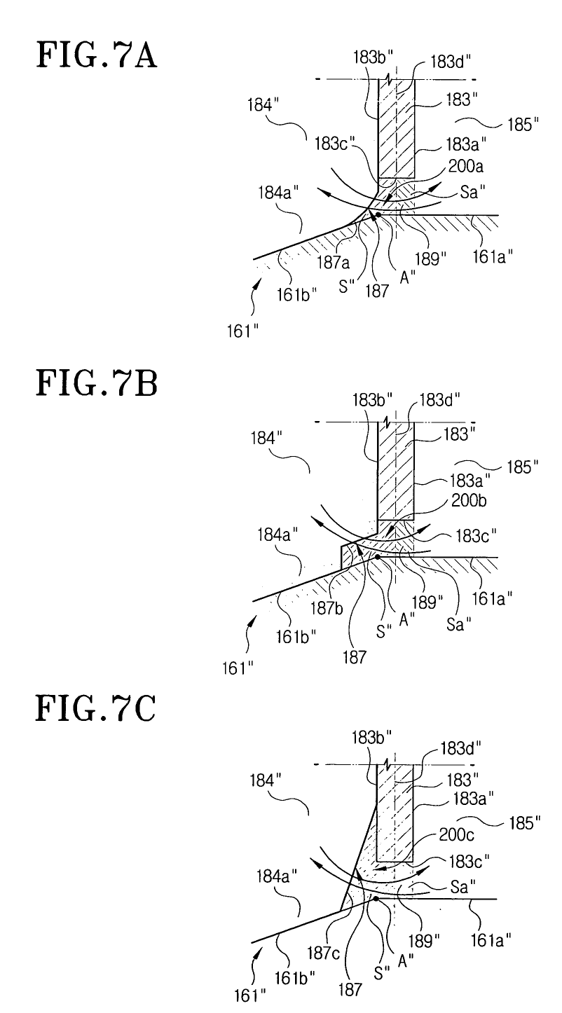

FIG. 6 shows a connecting hole blockage preventing structure 200′ employed in the ink cartridge of the present invention by way of a modified example.

The connecting hole blockage preventing structure 200′, like as in the connecting hole blockage preventing structure 200 of FIG. 5, is formed so that a first air liquid transfer space S′ is larger than a second air liquid transfer space Sa′ to prevent a connecting hole 189′ from being blocked with a negative pressure generating medium 184′ expanding in the negative pressure generating chamber. The first air liquid transfer space S′ is defined by a first face 184b′ forming an ink contact surface of the negative pressure generating medium 184′ adjacent the connection hole 189′, a second face 183c′ forming a bottom surface of the intermediate partition 183′ in the connecting hole 189′, a third face 161′ forming a bottom of a body and a first vertical plane extending vertically from a center face 183d′ of the intermediate partition 183′, whereas the second air liquid transfer space Sa′ is defined by the first vertical plane, the second face 183c′, the third face 161′ and a second vertical plane extending vertically from a wall surface 183a′ of the intermediate partition 183′ toward the ink chamber.

The first air liquid transfer space S′ is larger than the second air liquid transfer space Sa′ because the third face 161′ forms a portion of the connecting hole blockage preventing structure 200′ having an inclined surface 161b′ extending from a position “A′” to a position (not shown) at which an ink supply portion (not shown) is disposed. The inclined surface is inclined at a predetermined angle θ′ with respect to a horizontal surface, e.g., at an obtuse angle ranging from 90° to 180°, wherein the position “A′” is located toward an ink chamber by a predetermined distance “L′” from a third vertical plane extending vertically from a wall surface 183b′ of an intermediate partition 183′ toward the negative pressure generating chamber.

In this case, a lower surface of the negative pressure generating medium 184′ expanding in the negative pressure generating chamber adjacent to the intermediate partition 183′ has an inclined angle corresponding to the inclined surface 161b′ like the negative pressure generating medium 184 of FIG. 5. Accordingly, a triangular prism-shaped space is formed by the inclined surface 161b′ of the third face 161′, an extended plane from an non-inclined surface 161a′ of the third face 161′ other than the inclined surface 161b′, and the third vertical plane extending vertically from the wall surface 183b′ of the intermediate partition 183′ toward the negative pressure generating chamber, thereby preventing the negative pressure generating medium 184′ from expanding therein.

Also, in order to help prevent the negative pressure generating medium 184′ from being compressed and expanding in the triangular prism-shaped space, a corner of a lower surface of the negative pressure generating medium 184′ adjacent to the triangular prism-shaped space is additionally provided with a cut out portion (not shown) that is cut into a rounded shaped, an inclined shaped, or a stepped shaped as the same way of the negative pressure generating medium 184 shown in FIG. 5.

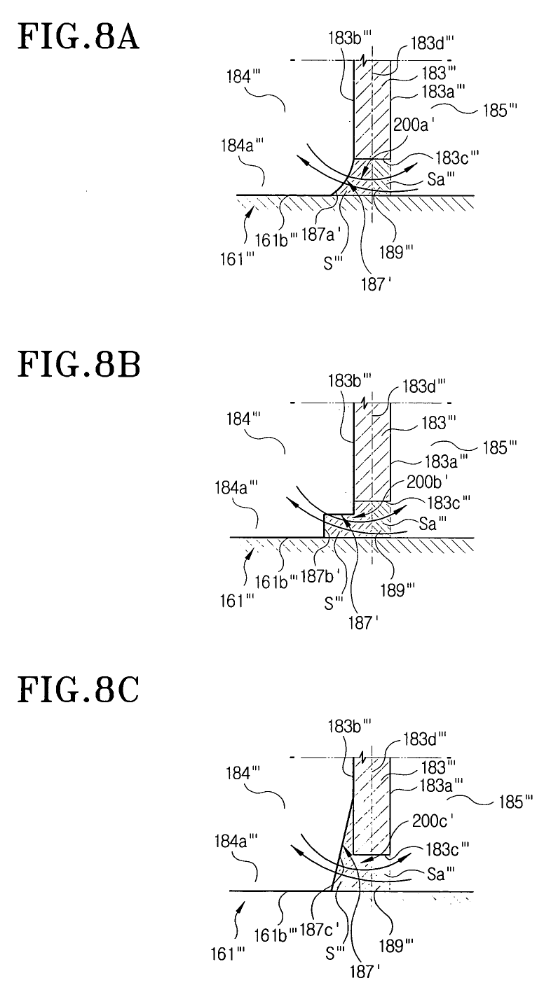

FIGS. 7A to 7C show connecting hole blockage preventing structures 200a, 200b, and 200c employed in the ink cartridge of the present invention by way of other modified examples.

Each of the connecting hole blockage preventing structures 200a, 200b and 200c has an inclined surface 161b″ extending from a position “A″”, at which a third vertical plane vertically extending from a wall surface 183b″ of an intermediate partition 183″ toward a negative pressure generating chamber is disposed, to a position (not shown) at which an ink supply portion (not shown) is disposed, and the inclined surface 161b″ being inclined at a predetermined angle θ″ e.g. at an obtuse angle ranging from 90° to 180° with respect to a horizontal surface. Also, the connecting hole blockage preventing structures 200a, 200b, and 200c respectively include a cut out portion 187 formed in a lower corner of a negative pressure generating medium 184″ adjacent to a connecting hole 189″.

The cut out portions 187 of respective connecting hole blockage preventing structures 200a, 200b and 200c are respectively formed in a rounded shape 187a, a stepped shape 187b, and an inclined shape 187c.

Also, the respective connecting hole blockage preventing structures 200a, 200b and 200c, like as in the connecting hole blockage preventing structures 200 and 200′ of FIGS. 5 and 6, are formed so that a first air liquid transfer space S″ is larger than a second air liquid transfer space Sa″ to prevent the connecting hole 189″ from being blocked with the negative pressure generating medium 184″ expanding in the negative pressure generating chamber. The first air liquid transfer space S″ is defined by a first face comprising the cut out portion 187 forming an ink contact surface of the negative pressure generating medium 184″ adjacent the connection hole 189″, a second face 183c″ forming a bottom surface of the intermediate partition 183″ in the connecting hole 189″, a third face forming a bottom 161″ of a body and a first vertical plane extending vertically from a center face 183d″ of the intermediate partition 183″, whereas the second air liquid transfer space Sa″ is defined by the first vertical plane, the second face 183c″, the third face and a second vertical plane extending vertically from a wall surface 183a″ of the intermediate partition 183″ toward the ink chamber.

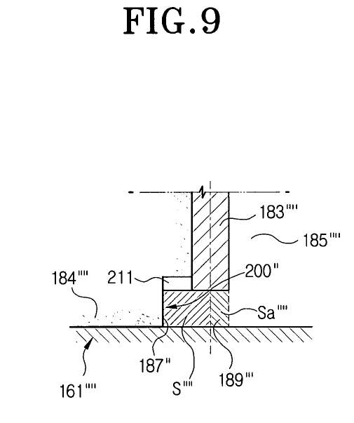

FIGS. 8A to 8C show connecting hole blockage preventing structures 200a′, 200b′ and 200c′ employed in the ink cartridge according to still other embodiments of the present invention.

Each of the connecting hole blockage preventing structures 200a′, 200b′ and 200c′ has a horizontal surface 161b′″ perpendicular to a first vertical plane vertically extending from a center face 183d′″ of an intermediate partition 183′″, and a cut out portion 187′ which is formed at a lower corner of a negative pressure generating medium 184′″ adjacent to a connecting hole 189′″.

The cut out portions 187′ of the connecting hole blockage preventing structures 200a′, 200b′ and 200c′ are respectively formed in a rounded shape 187a′, a stepped shaped 187b′, and an inclined shape 187c′.

The respective connecting hole blockage preventing structures 200a′, 200b′ and 200c′, like as in the connecting hole blockage preventing structures 200, 200′, 200a, 200b and 200c of FIGS. 5, 6, 7A, 7B and 7C, are formed so that a first air liquid transfer space S′″ is larger than a second air liquid transfer space Sa′″ to prevent the connecting hole 189′″ from being blocked with the negative pressure generating medium 184′″ expanding in the negative pressure generating chamber. The first air liquid transfer space S′″ is defined by a first face comprising the cut out portion 187′ forming an ink contact surface of the negative pressure generating medium 184′″ adjacent the connection hole 189′″, a second face 183c′″ forming a bottom surface of the intermediate partition 183′″ in the connecting hole 189′″, a third face forming a bottom 161′″ of a body and a first vertical plane extending vertically from a center face 183d′″ of the intermediate partition 183′″, whereas the second air liquid transfer space Sa′″ is defined by the first vertical plane, the second face 183c′″, the third face and a second vertical plane extending vertically from a wall surface 183a′″ of the intermediate partition 183′″ toward the ink chamber.

According to the color ink cartridge 100 of the present invention as constructed above, since the connecting hole blockage preventing structures 200, 200′, 200a, 200a′, 200b, 200b′, 200c, or 200c′ are formed around the connecting hole and having the first air liquid transfer spaces S, S′, S″ or S′″ larger that the second air liquid transfer spaces Sa, Sa′, Sa″ or Sa′″ to prevent the negative pressure generating medium from forming the compressed portion, it prevents the connecting hole from being blocked with the negative pressure generating medium and thus it solves the problem of unstable ink supply.

Although the embodiments of the present invention as depicted above are applied in the color ink cartridge 100, it should not be considered as limiting. The present invention can be applied in a black ink cartridge having the same structure as the color ink cartridge.

Also, instead of having the inclined surface and/or the cut out portion, the connecting hole blockage preventing structure of the ink cartridge of the present invention may take any form if it can prevent the negative pressure generating medium from forming the compressed portion and have a first air liquid transfer space larger than a second air liquid transfer space. For example, as shown in FIG. 9, a connecting hole blockage preventing structure 200″ includes a protruding guide 211 protruding toward a negative pressure generating chamber 184″″ and a cut out portion 187″ formed at a corner of a negative pressure generating medium 184″″ corresponding to the protruding guide 211, thereby the first air liquid transfer space S″″ being larger than the second air liquid transfer space Sa″″.

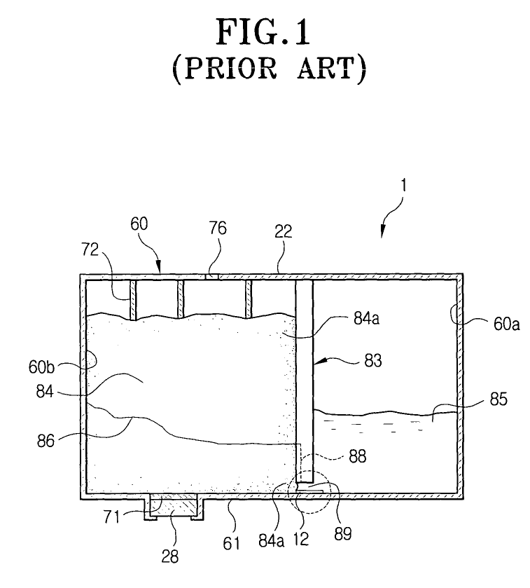

Since the ink cartridge 100 is operated in a similar way as that of the conventional ink cartridge 1 of FIG. 1 except for that the connecting hole is prevented from being blocked by the connecting hole blockage preventing structures 200, 200′, 200a, 200a′, 200b, 200b′, 200c, 200c′ or 200″, detailed descriptions are omitted.

As described above, the ink cartridge according to the present invention includes the connecting hole blockage preventing structure for preventing the connecting hole of the intermediate partition between the ink chamber and the negative pressure generating chamber from being blocked with the negative pressure generating medium such as the porous material expanding in the negative pressure generating chamber, thereby providing stable supply of ink from the ink chamber to the negative pressure generating chamber.

Also, since the ink cartridge of the present invention has the simplified connecting hole blockage preventing structure instead of a conventional protruding rib of a complicated structure, its fabrication is simplified.

Also, the ink cartridge of the present invention selectively uses a negative pressure generating medium of a high compression ratio corresponding to a change of environment such as temperature and pressure because the ink cartridge does not allow the negative pressure generating medium to be compressed around the connecting hole.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An ink cartridge comprising:
at least one first chamber storing an ink;
at least one second chamber having an air inflow hole formed at an upper portion thereof to be exposed to an ambient air and an ink supply portion formed at a lower portion thereof and having an ink supply port supplying an ink, the second chamber expanding with a negative pressure generating medium storing the ink; and
an intermediate partition having a connecting hole defined in a lower portion thereof, connecting the first and the second chambers to each other, the intermediate partition dividing the first and the second chambers;
wherein a first volume is larger than a second volume, the first volume being defined by a first face forming an ink contact surface of the negative pressure generating medium adjacent the connection hole, a second face forming a bottom surface of the intermediate partition in the connecting hole, a third face forming a bottom of the ink cartridge, and a first vertical plane extending vertically from a center plane of the intermediate partition and the second volume being defined by the first vertical plane, the second face, the third face, and a second vertical plane extending vertically from a wall of the intermediate partition facing the first chamber, preventing the connecting hole from being blocked with the negative pressure generating medium expanding in the second chamber.

2. The ink cartridge of claim 1, wherein the third face comprises an inclined surface extending toward the ink supply portion from a position, which is separated by a predetermined distance from a third vertical plane vertically extending from a second wall of the intermediate partition facing the second chamber by a predetermined distance, the inclined surface being inclined at a predetermined obtuse angle with respect to a horizontal surface.

3. The ink cartridge of claim 2, wherein the position is in the second chamber.

4. The ink cartridge of claim 3, wherein a lower surface of the negative pressure generating medium to expand in the second chamber adjacent to the intermediate partition is inclined at an angle corresponding to the angle of the inclined surface before the negative pressure generating medium expands in the second chamber, thereby preventing the negative pressure generating medium from being compressed and expanding in a substantially triangular space defined by an extended plane from the inclined surface of the third face, a non-inclined surface of the third face, and the third vertical plane as the negative pressure generating medium expands in the second chamber.

5. The ink cartridge of claim 4, wherein a corner of the lower surface of the negative pressure generating medium adjacent to the substantially triangular space has a cut out portion formed in one of a rounded shape, an inclined shape, and a stepped shape, thereby preventing the negative pressure generating medium from being compressed and expanding in the triangular prism-shaped space.

6. The ink cartridge of claim 5, wherein the obtuse angle of the inclined surface is measured from a non-inclined portion of the third face.

7. The ink cartridge of claim 2, wherein the position is disposed at a side of the first chamber.

8. The ink cartridge of claim 7, wherein a lower surface of the negative pressure generating medium to expand in the second chamber adjacent to the intermediate partition is inclined at an angle corresponding to the angle of the inclined surface before the negative pressure generating medium expands in the second chamber, thereby preventing the negative pressure generating medium from expanding in a substantially triangular space formed by the inclined surface of the third face, an extended plane from a non-inclined surface of the third face, and the third vertical plane.

9. The ink cartridge of claim 8, wherein a corner of the lower surface of the negative pressure generating medium adjacent to the substantially triangular space includes a cut out portion formed in one of a rounded shape, an inclined shape, and a stepped shape, thereby preventing the negative pressure generating medium from being compressed and expanding in the triangular prism-shaped space.

10. The ink cartridge of claim 9, wherein the obtuse angle of the inclined surface is measured from a non-inclined portion of the third face.

11. The ink cartridge of claim 1, further comprising a cut out portion at a corner of a lower surface of the negative pressure generating medium adjacent to the connecting hole.

12. The ink cartridge of claim 11, wherein the cut out portion is formed in one of a rounded shape, an inclined shape, and a stepped shape.

13. The ink cartridge of claim 12, wherein the third face comprises an inclined surface extending from a position, at which a third vertical plane vertically extending from the second wall is located, to a position at which the ink supply portion is located, the inclined surface being inclined an obtuse angle with respect to a horizontal surface.

14. The ink cartridge of claim 12, wherein the third face comprises a horizontal surface portion parallel to the horizontal plane.

15. An ink cartridge defining a cavity having an ink chamber in one side, a medium chamber, containing a medium in the other side, having an air inflow hole in an upper portion and an ink supply port in a lower portion, and an intermediate partition having a connection hole in a lower portion separating the sides, comprising:
a first volume within an area bounded by a vertical plane extending from a center of a bottom surface of the partition, the bottom surface of the partition on the medium chamber side, a surface of the medium, an exposed portion of a surface of the partition on the medium chamber side, and a base of the ink cartridge on the medium chamber side; and
a second volume smaller than the first volume within an area bounded by the vertical plane extending from the center of a bottom surface of the partition, the bottom surface of the partition on the ink chamber side, a vertical plane extending from the edge of the bottom surface of the partition on the ink chamber side, and the base of the ink cartridge on the ink chamber side.

16. The ink cartridge according to claim 15, further comprising magenta, cyan, and yellow ink chambers.

17. The ink cartridge according to claim 15, wherein the medium chamber contains a negative pressure generating medium including a porous material.

18. The ink cartridge according to claim 15, wherein the porous material is foam to store ink.

19. The ink cartridge according to claim 15, further comprising a filter on a stand pipe between the medium and the ink supply port to guide a flow of the ink.

20. The ink cartridge according to claim 15, wherein a portion of the base of the ink cartridge in the medium chamber side is inclined at an angle between 90 and 180 degrees from a non-inclined portion of the base toward the ink supply portion.

21. The ink cartridge according to claim 20, wherein the inclined portion begins at a position within the medium chamber side of the ink cartridge.

22. The ink cartridge according to claim 21, wherein the inclined portion prevents air bubbles from horizontally moving toward the ink supply port.

23. The ink cartridge according to claim 21, wherein a lower surface of the medium has an inclined angle substantially corresponding to the angle of the inclined surface.

24. The ink cartridge according to claim 23, wherein an extended plane from the inclined portion, a non-inclined portion of the base in the medium chamber side, and an extended face of the exposed portion of a surface of the partition on the medium chamber side form a triangular prism-space, thereby preventing the medium from expanding against interior surfaces of the medium chamber.

25. The ink cartridge according to claim 24, wherein a corner of the medium adjacent the triangular prism-space is cut out to prevent the medium from expanding against interior surfaces of the medium chamber.

26. The ink cartridge according to claim 25, wherein the cut out medium is rounded.

27. The ink cartridge according to claim 25, wherein the cut out medium is inclined.

28. The ink cartridge according to claim 25, wherein the cut out medium is stepped.

29. The ink cartridge according to claim 20, wherein the inclined portion begins at a position within the ink chamber side of the ink cartridge.

30. The ink cartridge according to claim 29, wherein the inclined portion prevents air bubbles from horizontally moving toward the ink supply port.

31. The ink cartridge according to claim 29, wherein a lower surface of the medium has an inclined angle substantially corresponding to the angle of the inclined surface.

32. The ink cartridge according to claim 15, wherein a corner of the medium adjacent the first volume is cut out to prevent the medium from expanding against interior surfaces of the medium chamber.

33. The ink cartridge according to claim 32, wherein the cut out medium is rounded.

34. The ink cartridge according to claim 33, wherein the cut out medium is inclined.

35. The ink cartridge according to claim 33, wherein the cut out medium is stepped.

36. The ink cartridge according to claim 15, further comprising a connection hole blockage preventing structure including a protruding guide protruding toward the medium chamber, and a cut out portion formed at a corner of the medium corresponding to a portion of the protruding guide.
